(19) United States
(12) Patent Application Publication
(10) Pub. No.: US 2024/0409353 A1
(43) Pub. Date: Dec. 12, 2024

(54) SHEET MATERIAL HOLDER FOR HOLDING SHEET MATERIAL

(71) Applicant: GIESECKE+DEVRIENT CURRENCY TECHNOLOGY GMBH, Munchen (DE)

(72) Inventors: Wolfgang KONIGER, Karlsfeld (DE); Michael KNICKREHM, Augsburg (DE); Andreas JAKOBS, Munchen (DE)

(21) Appl. No.: 18/699,710

(22) PCT Filed: Oct. 7, 2022
(86) PCT No.: PCT/EP2022/025468

§ 371 Date: Apr. 9, 2024

(30) Foreign Application Priority Data
Oct. 19, 2021 (DE) 10 2021 005 218.8

(51) Int. Cl. B65H 31/30; B33Y 80/00

(52) U.S. Cl. CPC B65H 31/3045; B33Y 80/00; B65H 2406/1132; B65H 2701/1912

(57) ABSTRACT

A sheet material holder for holding sheet material for a gripping system is arranged to bear on the sheet material by means of a first surface when the sheet material holder is holding the sheet material. The first surface includes at least a first opening and the sheet material holder is designed such that a fluid can be discharged through the first opening along a first predetermined discharging direction in the direction of the sheet material when the sheet material holder is holding the sheet material. A gripping system and a set-down system with the sheet material holder, and a method for setting sheet material down is also made available.

The present invention relates to a sheet material holder for holding sheet material for a gripping system. The invention furthermore relates to a gripping system for holding sheet material. According to the invention, a method for setting down sheet material is also provided.

In many areas of application, sheet material, e.g. value documents, sheets of paper, or sheets of film must be set down in an accurate position, e.g. on a stack of the sheet material. Thus, in the value document sector, use is made of value document cassettes in which the value documents are stored in the form of a stack. Value document cassettes of this kind can be designed for the automatic removal of value documents in a self-service device. Value document cassettes can be cassettes for banknotes, but other value documents may also be stored in such cassettes instead of banknotes, e.g. vouchers, tickets, checks etc. The known cassettes for banknotes can be used in self-service devices designed to remove the banknotes automatically from the cassettes. Self-service devices of this kind may be, for example, automatic telling machines (ATMs) that dispense a certain amount to a user and charge the amount dispensed to a user account. This amount is then made up of banknotes which are removed from the cassettes contained in the ATM and are dispensed to the user. It is customary here to use at least one dedicated cassette for each denomination.

ATMs can be designed to accept banknotes inserted by a user and to store them in one or more cassettes and to credit an amount ascertained during this process to the user account. Moreover, once they become empty over time on account of payouts, the cassettes must be replaced by other cassettes filled with banknotes of the respective denomination. For this purpose, emptied or partially emptied cassettes must be removed from the ATMs and then refilled with banknotes to enable them to be reused in an ATM. In both cases, value documents are set down in stack form in a cassette.

In processing value documents, it is customary, before putting them into a sorting device or after removing them from a sorting device, to transport the value documents in value document containers which, unlike value document cassettes, are not designed for automatic removal of value documents in an ATM. In a cash center, for example, banknotes are stored and transported in value document containers which are open on their upper side to enable the value documents to be easily placed in them and removed from them-manually or automatically. The value documents contained in such value document containers can be used to fill value document cassettes. In this case too, the value documents must be inserted into the value document containers in stack form.

Grippers are usually used for setting down value papers. A gripper of this kind closes in the manner of pincers around the sheet material (e.g. one or more banknotes) in order to grip it. After the gripper has moved the gripped sheet material into a desired set-down position, it can open in order to set down the sheet material in the set-down position. The gripper can then be moved away from the set-down position.

During the setting down of sheet material, it may happen that, owing to frictional forces between the sheet material and the opened gripper, the sheet material is moved with the gripper (partially) out of the set-down position or taken along by the gripper as the gripper is moved away or retracted. These frictional forces may be increased, for example, by the puffing up of the set-down sheet material. In this case, the sheet material which has already been set down, or even additional sheet material that is already in the set-down position, may be displaced from the set-down position. In particular, it is possible, during the movement of the gripper out of the set-down position, for the stack shape of sheet material situated in the set-down position to be com-promised to such an extent that the lateral edges of the individual sheets of the sheet material are no longer located accurately one above the other. The less accurately the sheet material is positioned, the more likely errors are to occur during subsequent removal or further processing of individual sheet material. It will be understood that this problem may exist not only in the value document sector but more generally in the handling of sheet material.

The object on which the invention is based is therefore to provide a sheet material holder and a method which allow sheet material to be set down in an accurate position.

According to the invention, this object is achieved by the subject matter of claim 1. A corre-sponding method is the subject matter of the independent method claim. Advantageous devel-opments of the invention are specified in the dependent claims.

According to a first aspect, a sheet material holder for holding sheet material is provided. This is interpreted to mean that the sheet material holder can hold sheet material in a fixed position relative to the sheet material holder. In particular, the sheet material holder can carry the sheet material.

The sheet material can be value documents (e.g. banknotes, checks, coupons etc.), pages consisting of paper (e.g. pages of books), sheets of paper or sheets of film. The term “sheet material” should be interpreted to mean a single piece of sheet material, that is to say, for example, a single banknote, and also a plurality of pieces of sheet material, that is to say, for example, a stack of banknotes or a plurality of sheets of film. The sheet material can also refer to sheet-like electrode elements for the production of batteries, e.g. for motor vehicles, e.g. electrode plates, separator films, prefabricated combinations of electrode plates and separators (monocells), mem-branes, or membrane-electrode assemblies (MEAs).

The sheet material holder has a first surface. The sheet material holder is designed to bear on the sheet material by means of the first surface when the sheet material holder is holding the sheet material. This surface can therefore also be referred to as a contact surface, supporting surface or holding surface. If the sheet material holder carries the sheet material, the sheet material, in particular, can rest on the first surface.

The first surface has at least one first opening, preferably a plurality of first openings. The first opening can be a cutout or a drill hole, for example. The sheet material holder is designed such that a fluid can be discharged, e.g. being blown out or made to flow out, through the first opening along a first predetermined discharging direction in the direction of the sheet material when the sheet material holder is holding the sheet material. This should be interpreted to mean that the fluid can be discharged, e.g. being blown out or made to flow out, toward the sheet material when the sheet material holder is holding the sheet material. By means of this design, it is possible to discharge the fluid, e.g. to blow it out or make it flow out, onto a surface of the sheet material being held. It is thereby possible to reduce the friction between the sheet material holder and the sheet material held by the latter in the manner of an air cushion. It is also possible, by appropriate selection of the fluid and the speed of discharge thereof as well as by appropriate dimensioning of the first opening, to control the friction as desired, in particular in a manner that varies with respect to time. This reduced friction makes it possible to move the sheet material holder out of the set-down position without significantly prejudicing the position of the sheet material. Ultimately, therefore, accurately positioned set-down and release of the sheet material is made possible by virtue of the reduced friction. Moreover, damage to the sheet material by the sheet material holder as it moves away is avoided.

The fluid can be a liquid (e.g. water, especially deionized water) or a gas, e.g. an ionized gas. For example, the gas is a gas mixture, e.g. an ionized gas mixture, especially ionized air. Using ionized gases makes it possible to reduce any attraction between the sheet material and the sheet material holder due to static charge effects. If the sheet material comprises sheet-like electrode elements for producing a redox flow battery, the fluid that is made to flow out can be an electrolyte solution used to produce the redox flow battery, in particular the electrolyte solution used for the initial filling of the redox flow battery. This simplifies the production process.

The sheet material holder can be designed such that the first predetermined discharging direction is the direction of the normal of the sheet material or runs at an acute angle to the normal of the sheet material when the sheet material holder is holding the sheet material. Here, the normal can refer to the region of the sheet material which lies opposite the first opening or bears on the latter. In particular, the acute angle can be between 0° and 45°, preferably between 0° and 30°. These angles have proven to be particularly effective in reducing friction. Particularly in the case of an angle between 0° and 45°, movement of the sheet material relative to the sheet material holder due to a fluid flow can be minimized.

The sheet material holder can be designed such that the sheet material (e.g. as a whole or over its entire surface) is flat or/and runs parallel to the first surface when the sheet material holder is holding the sheet material. The first surface can be flat (e.g. overall or over its entire surface). It is thereby possible to ensure that a uniform fluid cushion forms between the sheet material holder and the sheet material as the fluid is discharged. In other words, this configuration allows a further reduction in friction.

The sheet material holder can have at least one finger. The finger can be designed such that it extends along the sheet material when the holder is holding the sheet material. The finger can have or form the first surface or a part of the first surface. Here, the term “form” should be interpreted to mean that the first surface consists exclusively of one or more surface segments of the finger(s). The respective finger can furthermore have at least one of the first openings. As a preferred option, a plurality of the first openings is arranged along a longitudinal direction of the respective finger. In this case, the first openings can be arranged along a line or offset relative to one another. The finger can have a length which is in a ratio of ≥2:1, preferably ≥4:1, in particular ≥6:1, e.g. 8:1, to its width. Non-integral ratios are also possible. A finger of this kind can allow reliable holding of the sheet material. If the sheet material is held by means of the finger, it is furthermore possible to minimize a supporting surface between the sheet material and the sheet material holder.

In particular, the sheet material holder can comprise a plurality of such fingers, which each have (e.g. part) of the first surface. The fingers can be spaced apart. The plurality of fingers can form the first surface. Here, the term “form” should be interpreted to mean that the first surface consists exclusively of one or more surface segments of the fingers. Thus, the first surface does not necessarily have to be integral or continuous. The fingers can run parallel to one another. The fingers can extend in the same plane, in particular in a plane which is parallel to the first surface. Each of the fingers can be designed such that it extends along the sheet material when the holder is holding the sheet material. A plurality or all of the fingers can comprise one or more of the at least one first opening. As a result, the sheet material can be held even more securely, while the minimization of friction continues to be ensured. The use of a plurality of fingers can also improve the flatness of sheet material that is being held.

The sheet material holder can have a second surface. The second surface has at least one second opening, for example. The sheet material holder can be designed such that a fluid can be discharged, in particular blown out or made to flow out, through the at least one second opening along a second predetermined discharging direction from the direction of the sheet material when the sheet material holder is holding the sheet material. In other words, the fluid can be discharged through the second opening in such a way that it flows away from the sheet material when the sheet material holder is holding the sheet material. This is advantageous particularly when, in the set-down position, the sheet material holder is in contact by means of the second surface with an object whose position is not supposed to be changed as the sheet material holder is moved away out of the set-down position. Here too, as already described above, the discharged fluid can reduce the friction between the sheet material holder and the object in the manner of an air cushion. This object can be, for example, sheet material that has already been set down, stored and stacked, e.g. sheet material present in a value paper cassette to be filled. It is thus possible, for example, to prevent the sheet material holder from displacing an uppermost sheet in a stack by means of the second surface when it is moving out of the set-down position.

The first predetermined discharging direction can differ from the second predetermined discharging direction, it being possible, in particular, for these directions to be opposed and to run parallel, or to be opposed and to run at an (e.g. acute) angle. For example, the sheet material holder is designed such that the second predetermined discharging direction is the direction of the normal of the sheet material or runs at an acute angle, in particular of at most 45°, to the normal of the sheet material when the sheet material holder is holding the sheet material. The fluid can be the same fluid which can or is to be discharged through the first opening. The second surface can be situated on an opposite side of the sheet material holder or of the finger(s) from the first surface. This configuration is advantageous, in particular, when setting sheet material down on a stack of sheet material that is already present. The first surface can be parallel to the second surface. The at least one first opening can lie opposite the at least one second opening.

The finger can have or form (e.g. a part of) the second surface. The finger can have the at least one second opening. Each of the plurality of fingers can have (e.g. part of) the second surface. The plurality of fingers can form the second surface. For example, a plurality or all of the fingers can comprise one or more of the at least one second opening. This can enable the advantageous use, already described above, of one or more fingers.

The sheet material holder can comprise a fluid channel which is arranged at least partially within the finger and is connected fluidically (i.e. via a fluid line) to the at least one first opening or/and to the at least one second opening. The same can apply to each of the fingers, which comprise one or more of the at least one first opening or/and one or more of the at least one second opening. If the sheet material holder comprises a plurality of fingers, it can comprise a common supply channel, which is connected fluidically to each of the fluid channels. The supply channel can be arranged in an interior of a finger connecting element of the sheet material holder, wherein each of the fingers is connected to the finger connecting element, in particular being fastened thereto or being produced integrally therewith. It is thereby possible inter alia to provide a compact, lightweight construction.

The sheet material holder can be produced at least partially, in particular completely, by an additive manufacturing method. The additive manufacturing method can comprise an application of material with directional energy input, extrusion of material, application of material by a free jet, melting based on a powder bed, layer lamination or/and bath-based photopolymerization. The fluid channel or/and the supply channel can have a cross section which does not require any supporting structures during manufacture by means of the additive manufacturing method. As a result, it is possible to produce the sheet material holder in a simple and low-cost way, it being possible, in particular, to eliminate additional machining steps for the introduction of the first or second opening, the fluid channel or/and the supply channel.

According to a second aspect, a gripping system for holding sheet material is provided, said system being designed, in particular, for gripping, transporting and releasing sheet material. The gripping system comprises a first sheet material holder according to the first aspect and a second sheet material holder according to the first aspect. The first and second sheet material holders do not have to be identical: in other words, these sheet material holders can comprise different features from those described with reference to the first aspect. In particular, it may be sufficient if just one of the two sheet material holders has the at least one second opening. This sheet material holder with the at least one second opening is preferably the sheet material holder which comes or would come into contact with the additional object when setting down the sheet material.

The sheet material holders of the gripping system are arranged in such a way that the first surface of the first sheet material holder faces the first surface of the second sheet material holder. The gripping system is designed to hold the sheet material between the first surface of the first sheet material holder and the first surface of the second sheet material holder. This is advantageous particularly when the sheet material is to be transported and set down in an accurate position by means of the gripping system. By means of this arrangement of the two sheet material holders, it is possible to reduce the friction in relation to the sheet material holders on both sides of the sheet material being held.

The sheet material holders can furthermore be arranged in such a way that the first sheet material holder can be moved relative to the second sheet material holder in order to change a distance between the first surface of the first sheet material holder and the first surface of the second sheet material holder. The sheet material holders can be arranged in such a way that they can be moved relative to one another along a (e.g. just one) predetermined axis. In particular, the gripping system can have a translational drive, which is designed to change the distance between the first surface of the first sheet material holder and the first surface of the second sheet material holder, in particular to reduce it in order to grip the sheet material by means of the sheet material holders and to increase it in order to release the sheet material from the sheet material holders and thereby set down the sheet material. By increasing the distance between the first surfaces, the gripping system can be transferred into an open or release state and, by reducing the distance, the gripping system can be transferred into a closing or gripping or clamping state. In other words, changing the distance between the first surfaces can provide a secure gripping function and a reliable set-down process using the two sheet material holders.

The sheet material holders can be arranged in such a way that the first surface of the first sheet material holder is oblique with respect to the first surface of the second sheet material holder (e.g. at an angle of ≤10°, in particular ≤7.5°, e.g. ≤5°, preferably) 4° when the first sheet material holder and the second sheet material holder are not holding any sheet material. In this case, the distal ends of the sheet material holders or of the fingers can be closer together than the proximal ends thereof. The system can be designed such that the first surface of the first sheet material holder can be aligned parallel to the first surface of the second sheet material holder, counter to a restoring force. The restoring force can be provided by a force storage element, e.g. a spiral spring, a leaf spring, a rubber buffer or some other spring element. The spring force is provided, for example, by the finger or fingers of at least one of the sheet material holders in the manner of a bending beam. It is thereby possible to ensure that the sheet material is held securely and does not accidentally fall out of the gripping system. The first surface of the first sheet material holder then runs substantially parallel to the first surface of the second sheet material holder when sheet material is being held between the first sheet material holder and the second sheet material holder.

According to a third aspect, a set-down system is provided. The set-down system is designed for setting down sheet material and comprises the sheet material holder according to the first aspect or the gripping system according to the second aspect. The set-down system may also comprise a fluid supply unit, which is fluidically connected to the sheet material holder(s) and is designed to discharge the fluid from the at least one first opening in the direction of the sheet material. The system according to the third aspect furthermore comprises a movement system, which is designed to move the sheet material holder(s), in particular along a direction parallel to the sheet material surface. The set-down system furthermore comprises a control device. The control device is designed to instruct the movement system to move sheet material to a set-down position when the sheet material is being held by the sheet material holder(s). For this purpose, the sheet material holder(s) can be moved in such a way by the movement system that the sheet material is moved to the set-down position. The control device is designed to instruct a translational drive of the sheet material holder to increase a distance between the sheet material hold-er(s) in order to release the sheet material from the sheet material holder(s). And the control device is designed to instruct the fluid supply unit to discharge the fluid, e.g. blow it or make it flow, from the at least one first opening. The control device is furthermore designed to instruct the movement system to move the sheet material holder(s) relative to the sheet material during the discharging of the fluid in such a way that the sheet material is set down from the sheet material holder(s). The control device is preferably designed to bring it about that the discharging of the fluid by the fluid supply unit is started only for the setting down of the sheet material, in particular before or simultaneously with the step of moving the at least one sheet material holder relative to the sheet material, which is carried out for the purpose of set-down.

The fluid supply unit can furthermore be designed to discharge the fluid or an additional fluid, e.g. blow it or make it flow, from the at least one second opening. Accordingly, the control device can be designed to instruct the fluid supply unit to discharge the fluid or the additional fluid from the at least one second opening. The fluid supply unit can comprise at least one gas valve and at least one connection point for a compressed gas connection. The fluid supply unit can furthermore comprise a compressed gas source, e.g. a compressor or a compressed gas cylinder, coupled to the compressed gas connection. The movement system can comprise a robot arm (e.g. a robot arm capable of multi-axial movement), a bogie or a cable-controlled and sus-pended carriage. The movement system can have a translational drive, in particular a spindle drive, which is designed to change the distance between the sheet material holders, in particular between the two first surfaces of the sheet material holders.

According to a fourth aspect, a method for setting down sheet material is provided. The method comprises a step of moving sheet material to a set-down position, wherein the sheet material is held by at least one sheet material holder, in particular by two of the abovementioned sheet material holders, wherein a surface (e.g. the first surface) of the at least one sheet material holder bears on the sheet material. The sheet material holder can be, for example, the sheet material holder according to the first aspect, one of the sheet material holders from the gripping system according to the second aspect, or the sheet material holder(s) from the set-down system according to the third aspect. The method also comprises increasing a distance between the first and a second of the at least one sheet material holder, in particular by means of the gripping system according to the second aspect, in order to release the sheet material held between the first sheet material holder and the second sheet material holder from the sheet material holder(s). The method furthermore comprises a step of discharging a fluid from at least one opening (e.g. a first opening) in the surface (e.g. the first surface) of the at least one sheet material holder, wherein the fluid is discharged, e.g. being blown out or made to flow out, in the direction of the sheet material. The method also comprises a step of moving the at least one sheet material holder relative to the sheet material, in particular along a direction parallel to the sheet material surface, during the discharging of the fluid, such that the sheet material is set down from the at least one sheet material holder. The discharging of the fluid is preferably started only for the setting down of the sheet material, in particular after the movement of the sheet material into the set-down position, e.g. before, during or after the step of increasing the distance.

The discharging of the fluid is preferably started before or simultaneously with the step of moving the at least one sheet material holder relative to the sheet material (in particular along the direction parallel to the sheet material surface), which is carried out for the purpose of set-down, and is maintained during the (entire or at least at the start of the) relative movement. The discharging of the fluid is preferably carried out until the sheet material holder is no longer touching the sheet material after the setting down of the sheet material (during the retraction of the sheet material holder along the sheet material). This ensures that the sheet material is no longer made to slip by the sheet material holder after set-down, in particular when said holder is being moved along the direction parallel to the sheet material surface.

The method can be carried out by the set-down system according to the third aspect. The control unit of the set-down system according to the third aspect can be designed to control the fluid supply unit and the movement system such that the method according to the fourth aspect is carried out.

The present invention is described below by way of example with reference to the attached drawings, wherein the same reference signs indicate the same structural or/and functional features. In the drawings:

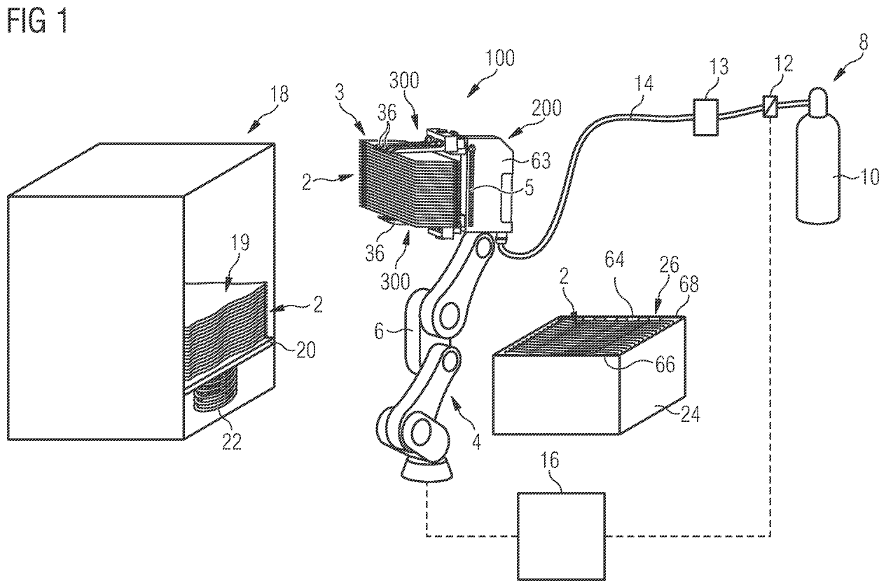

FIG. 1 shows a preferred embodiment of a set-down system;

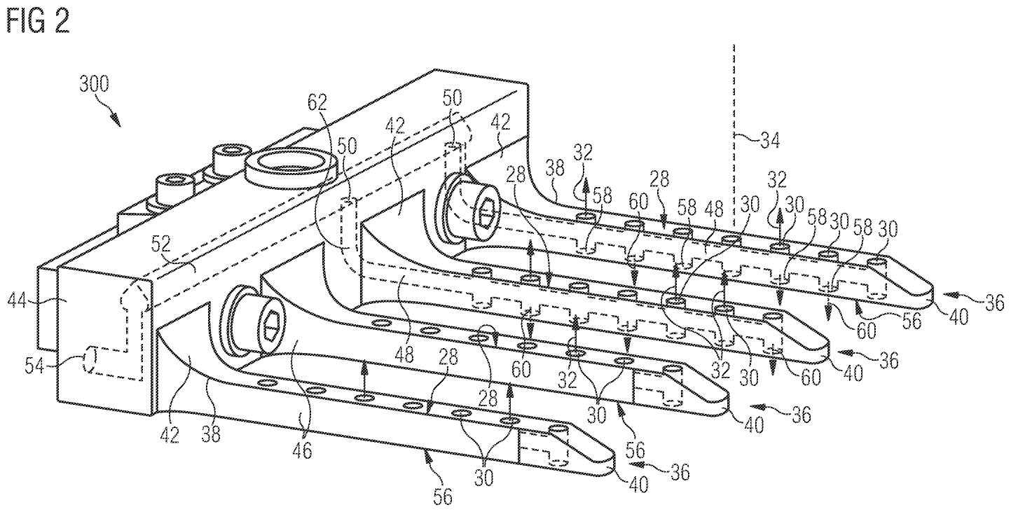

FIG. 2 shows a preferred embodiment of a sheet material holder;

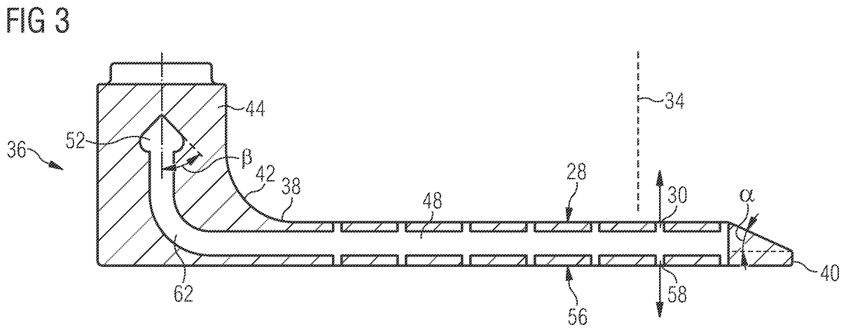

FIG. 3 shows a cross section through a finger of the sheet material holder from FIG. 2;

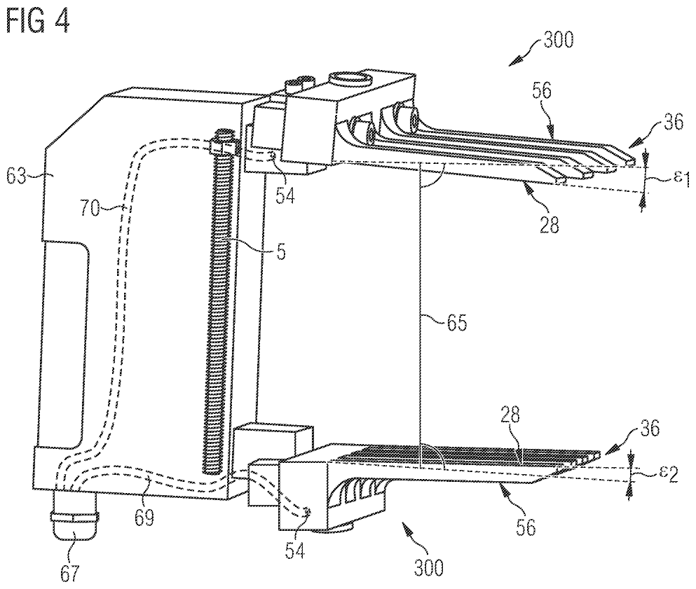

FIG. 4 shows a preferred embodiment of a gripping system; and

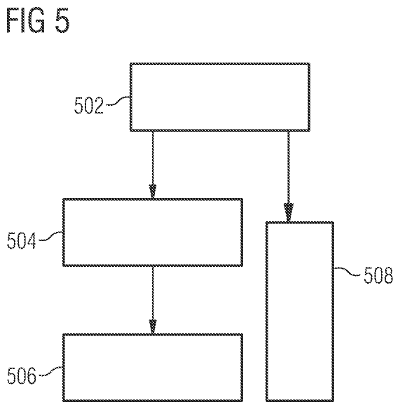

FIG. 5 shows a preferred embodiment of a method.

FIG. 1 illustrates a preferred embodiment of a set-down system 100 according to the present disclosure. The set-down system is designed for setting down sheet material 2 and, in the example illustrated, comprises a gripping system 200, which in turn comprises two sheet material holders 300. As can be seen in FIG. 1, the gripping system 200 can grip a stack 3 of the sheet material 2. In the example shown, the sheet material 2 comprises value documents, e.g. banknotes.

The gripping system 200 can be moved by a movement system 4, which, in the example shown, comprises a robot arm 6, which can move the gripping system 200 in space. In this case, the movement system 4 furthermore comprises a translational drive 5, which is designed to move the two sheet material holders 300 relative to one another in the manner of a gripper, it being sufficient for one of the two sheet material holders 300 to be moved. The translational drive 5 can comprise a spindle drive.

The set-down system 100 furthermore comprises a fluid supply unit 8, which is fluidically connected to each of the sheet material holders 300. In the example according to FIG. 1, the fluid supply unit 8 comprises a compressed gas cylinder 10, which is connected to the two sheet material holders 300 via a controllable valve 12 and a connecting hose 14. Alternatively or in addition to the compressed gas cylinder 10 and the valve 12, a compressor could be provided. The fluid supply unit 8 can be designed to supply ionized gas. For this purpose, it can comprise an ionizer 13.

The set-down system 100 furthermore comprises a control device 16, which is designed to control the movement system 4 and the fluid supply unit 8, in particular the valve 12.

FIG. 1 furthermore illustrates a value document cassette 18 which already holds ready a stack 19 of the sheet material 2, in the present case a stack of value documents. This stack 19 is placed on a movable lifting base 20, which is pushed in a predetermined direction by a spring 22. In the state illustrated, the lifting base is moved downward against the spring force (on account of the weight of the stack of sheet material, for example), thereby freeing a space above the stack. The stack 3 can now be inserted into this space. The set-down system 100 can therefore set down the sheet material 2 in the form of stack 3 on stack 19 in the value document cassette 18. The value document cassette 18 can be arranged vertically or can be arranged so as to slope obliquely backward (to the left in FIG. 1).

The set-down system 100 can be designed to remove the sheet material 2 from a value document container 24, which in turn holds ready a stack 26 of the sheet material 2. Transport of the sheet material 2 in the opposite direction, that is to say from the value document cassette 18 to the value document container 24, is also possible.

After the gripping system 200 has been moved by the movement system 4 such that stack 3 is above stack 19 in the value document cassette 18, the gripping system 200 can be opened in order to let go or release the stack 3 clamped between the sheet material holders 300. The gripping system 200 can then be pulled out of the value document cassette 18 in order to set stack 3 down on stack 19 in an accurate position. During this retraction of the gripping system 200, the friction between the sheet material holders 300 and the sheet material 2 of stack 3, preferably also of stack 19, is deliberately minimized. This is because, the lower the friction, the less is the risk that the gripping system 200 will pull individual sheets of the sheet material 2 at least partially out of stack 3 or 19 as it is retracted. To reduce the friction, a sheet material holder according to FIG. 2 can be used.

FIG. 2 shows a preferred embodiment of a sheet material holder. This sheet material holder 300 can be part of the set-down system 100, in particular of the gripping system 200. The sheet material holder 300 according to FIG. 2 has a first surface 28. This surface bears on the sheet material 2 when the sheet material holder 300 is holding the sheet material 2. In FIG. 2, the sheet material 2 would rest on the first surface 28 if the sheet material holder 300 were carrying the sheet material 2. In this case, the sheet material holder 300 can be designed such that the sheet material 2 runs flat and parallel to the first surface 28 when it bears on the first surface 28.

In the example shown, the first surface 28 is formed by a plurality of fingers 36. The fingers are each of elongate design and extend from a proximal end 38 to a distal end 40. At the distal end 40, the fingers 36 are beveled. In other words, the fingers 36 can be pointed or wedge-shaped at the distal end 40. This can facilitate insertion of the fingers 36 into a stack of sheet material 2. At the proximal end 38, the fingers 36 have a widened portion 42, which is secured on a finger connecting element 44 or merges into the finger connecting element 44. Each of a plurality of reinforcing elements 46 is secured on the finger connecting element 44 and on one side of the fingers 36. In the example according to FIG. 2, the reinforcing elements 46 extend substantially orthogonally to the first surface 28. This can reinforce the fingers 36 and prevent unwanted bending or breakage when gripping the sheet material 2. For this purpose, the reinforcing elements can consist of metal, for example.

The stack 26 is arranged between side walls 66, 68 of the value document container 24. To enable the stack 26 to be gripped easily, the side walls 66, 68 of the value document container 24 from FIG. 1 can comprise cutouts 64 on their inner sides, which face the stack, said cutouts being dimensioned in such a way that the fingers 36 of the sheet material holder 300 can be inserted into these cutouts. As illustrated in FIG. 1, the sheet material can then be arranged in the value document container 24 in such a way that it runs parallel to the side walls 66, 68.

Referring again to FIG. 2, the first surface 28 comprises a plurality of first openings 30. The sheet material holder 300 is designed such that a fluid can be discharged through these first openings 30 along a predetermined discharging direction 32 in the direction of the sheet material 2 held by the sheet material holder 300 (upward in FIG. 2). This discharging direction 32 is indicated schematically in FIG. 2 by means of arrows. The discharging direction 32 can differ depending on the opening 30, as long as it is in the direction of the sheet material 2. The discharging direction 32 is preferably the same for all the openings 30. As can be seen in FIG. 2, the discharging direction 32 can be at an acute angle to a normal 34 of the sheet material 2 (not illustrated), in particular at an angle of at most 45°, e.g. along the fingers 36 or transversely to the fingers 36. The discharging direction 32 can also be in the direction of the normal 34. In the example according to FIG. 2, each of the fingers 36 has a plurality of first openings 30.

As indicated in FIG. 2, a fluid channel 48 connected to the first openings 30 can run in the sheet material holder 300. According to FIG. 2, a common supply channel 52 connected to each fluid channel 48 is arranged in the finger connecting element 44. The fluid channels 48 enter the supply channel 52 in transitional regions 50. The supply channel 52 has a supply interface 54, which can be connected to the fluid supply unit 8, in particular to the hose 14. The fluid can flow out of the gas cylinder 10, via the open valve 12 and the hose 14, through the supply channel 52, from where it reaches the individual fluid channels 48 and is ultimately discharged through the first openings 30 along the discharging direction(s) 32. By switching on the fluid discharge, it is thus possible to reduce the friction between the sheet material 2 held by the sheet material holder 300 and the fingers 36 when required.

In the example illustrated, the sheet material holder 300 also has a second surface 56, which is formed by the fingers 36 and lies opposite the first surface 28 (that is to say against the under-side of the fingers 36 in FIG. 2). This second surface 56 also has openings, which are referred to as second openings 58. The fluid flowing through the fluid channels 48 to the second openings 58 can be discharged through the second openings 58 along a second predetermined discharging direction 60. The second discharging direction 60 can be opposite to the first discharging direction 32 and is downward in FIG. 2, i.e. away from the sheet material 2, when the sheet material holder 300 is holding the sheet material 2.

FIG. 3 illustrates a cross section of a finger 36 of the sheet material holder 300 from FIG. 2. It can be seen that the finger 36 extends substantially in a straight line, i.e. in one plane. The first surface 28 is parallel to the second surface 56. At the distal end 40, the finger 36 is beveled at an angle α, which can be in the range from 10° to 35°, for example. The first openings 30 are situated on the upper side of the finger 36, and the second openings 58 are situated on the under-side thereof. The number of first openings 30 corresponds to the number of second openings 58, although these could also be different. For example, the first predetermined discharging direction 30 runs parallel to the normal 34, as does the second predetermined discharging direction 58. According to FIG. 2 and FIG. 3, the two discharging directions 30, 58 are opposite one another.

The fluid channel 48 is connected to the first openings 30 and to the second openings 58. A first portion of the fluid channel 48 can run in a straight line in one plane. The fluid channel 48 can be at the same distance from the first surface 28 and from the second surface 56, in other words the material thickness of the finger 36 above the fluid channel 48 can be the same as the material thickness of the finger 36 below the fluid channel 48. The first portion of the fluid channel 48 can be arranged in a center of the finger 36. In this way, it is possible, for example, to ensure that the finger 36 is of high strength while being of compact construction.

In the example shown, the supply channel 52 can have a cross section which allows additive manufacture without supporting structures. According to FIG. 3, this is ensured by a maximum overhang angle of β=45°. The cross section of the supply channel can have an inverted heart shape. The supply channel 52 runs outside the plane (above it in FIG. 3) in which the first portion of the fluid channel 48 runs. A second portion of the fluid channel 48 runs in a curve out of the plane of the first portion of the fluid channel 48 (upward in FIG. 3) and is connected to the supply channel 52. Particularly with this type of construction, it may be advantageous to produce the finger 36, the finger connecting element 44, both or even the entire sheet material holder (e.g. simultaneously) by means of an additive manufacturing method, e.g. 3D printing.

FIG. 4 shows a preferred embodiment of a gripping system. The gripping system 200 shown can be used in the set-down system 100 according to FIG. 1. The translational drive 5 is also illustrated. The translational drive 5 is arranged in or on a hand element 63. Two sheet material holders, in particular the sheet material holders 300 according to FIGS. 2 and 3, are arranged on the hand element 63 in such a way that the two first surfaces 28 face one another. The two sheet material holders 300 are connected to one another via the hand element 63. The hand element 63 furthermore comprises a fluid connection coupling 67 and channels or hoses 69, 70 connected thereto, which are each connected to a respective supply interface 54 of the sheet material holders 300. The fluid connection coupling 67 can be connected to the hose 14.

The surface 28 of the sheet material holder 300 illustrated at the top in FIG. 4 can be slightly oblique with respect to the surface 28 of the other sheet material holder 300 when no sheet material 2 is being held by the gripping system 200, that is to say therefore that the gripping system 200 is not exerting any holding force. In the example, the angle ε=ε1+ε2 between the two surfaces 28 is 4°. It will be understood that this angle can be provided by tilting one or both sheet material holders 300 relative to the reference straight line 65. Thus, for example, both surfaces 28 could be at an angle of 88° to the normal 34, or one of the surfaces 28 could be at an angle of 90° and the other at an angle of 86°. The gripping system 200 can be designed such that the angle ε can be reduced to 0° against a restoring force. The restoring force can correspond to an clastic deformation of the sheet material holder 300 or can be provided by a separate spring element. Thus, the fingers 36 of the two sheet material holders 300 act like a clamp, increasing a contact pressure in the region of the distal ends 40 on sheet material 2 held between the sheet material holders 300. In this way, unwanted slipping out of sheet material 2 which is being held can be prevented. The reference straight line 65 can run parallel to the normal 34 of the sheet material 2 when the latter is being held or gripped by the gripping system 200.

At least one of the sheet material holders 300 is arranged in such a way that it can be moved by the translational drive 5. In this way, a distance between the surfaces 28 can be changed. In other words, the sheet material holders 300 can be moved toward one another and away from one another in the manner of a gripper.

FIG. 5 schematically illustrates a method according to the present disclosure. In a step 502, sheet material (e.g. the sheet material 2) is moved to a set-down position, wherein the sheet material is held by at least one sheet material holder (e.g. by one or both sheet material holders 300), wherein one surface (e.g. the first surface 28) of the at least one sheet material holder bears on the sheet material. In a step 504, a distance between a first and a second of the at least one sheet material holder between which the sheet material is being held is increased (e.g. between the two sheet material holders 300 of the gripping system 200). In a step 508, a fluid is discharged from at least one opening (e.g. the first openings 30) in the surface of the at least one sheet material holder, wherein the fluid is discharged in the direction of the sheet material (e.g. along the first predetermined discharging direction 32). Here, the discharging of the fluid according to step 508 starts during step 504. In a step 506, the at least one sheet material holder is moved relative to the sheet material or pulled away from the sheet material while the fluid is being discharged, with the result that the sheet material is set down from the at least one sheet material holder. With or after set-down according to step 506, the discharging of the fluid is end-ed.

The method can be carried out by the set-down system 100. Thus, the control device 16 can be designed to instruct the movement system 4, in particular the robot arm 6, to move the sheet material 2 of stack 3 into a set-down position, e.g. into a position above stack 19 within the value document cassette 18. The control device 16 can also be designed to control the spindle drive 5 in order to increase the distance between the two sheet material holders 300 (e.g. the first surfaces 28 thereof) of the gripping system 200. The control device 16 can furthermore be designed to instruct the fluid supply unit 8 to discharge the fluid from the opening(s) 30 or/and 58. The control device 16 can furthermore be designed to instruct the movement system 6, in particular the robot arm 6, to move the sheet material holder 300 relative to the sheet material 2 of stack 3 during the discharging of the fluid, such that the sheet material 2 is set down from the sheet material holder 300.

The control unit 16 can be designed to instruct the fluid supply unit 8 to discharge a certain fluid. The control unit 16 can be designed to instruct the fluid supply unit 8 to discharge the fluid at a defined pressure or a defined volume flow. This enables friction minimization that varies with time. The control parameters for the fluid supply unit 8 can be chosen to match the sheet material (e.g. paper, plastic etc.), size of the sheet material (e.g. 5 euro banknote size, 100 euro banknote size etc.), weight of the sheet material (e.g. weight per sheet of the sheet material) or condition of the sheet material (e.g. stiff or floppy) in order to ensure that the sheet material is set down in an accurate position.

It will be understood that the features explained with reference to the figures do not necessarily have to be present. Thus, alternatives or the omission of individual features are also con-ceivable. In other words, the features described with reference to the figures should not all be considered essential. Modifications of the exemplary embodiments are possible.

1.-15. (canceled)

16. A sheet material holder for holding sheet material for a gripping system, wherein the sheet material holder has a first surface,
wherein the sheet material holder is designed to bear on the sheet material by means of the first surface when the sheet material holder is holding the sheet material,
wherein the first surface has at least one first opening,
wherein the sheet material holder is designed such that a fluid can be discharged through the first opening along a first predetermined discharging direction in the direction of the sheet material when the sheet material holder is holding the sheet material.

17. The sheet material holder according to claim 16, wherein the sheet material holder is designed such that the first predetermined discharging direction is the direction of the normal of the sheet material or runs at an acute angle to the normal of the sheet material when the sheet material holder is holding the sheet material.

18. The sheet material holder according to claim 16, wherein the sheet material holder has one or more fingers, which form the first surface.

19. The sheet material holder according to claim 18, wherein one or more or all of the fingers in each case have at least one of the first openings,
wherein at least two of the first openings are arranged along a longitudinal direction of the respective finger.

20. The sheet material holder according to claim 16, wherein the sheet material holder has a second surface,
wherein the second surface has at least one second opening,
wherein the sheet material holder is designed such that a fluid can be discharged through the at least one second opening along a second predetermined discharging direction from the direction of the sheet material when the sheet material holder is holding the sheet material.

21. The sheet material holder according to claim 20, wherein the sheet material holder is designed such that the second predetermined discharging direction is the normal of the sheet material or runs at an acute angle to a normal of the sheet material when the sheet material holder is holding the sheet material.

22. The sheet material holder according to claim 20, wherein the second surface is situated on an opposite side of the sheet material holder from the first surface.

23. The sheet material holder according to claim 16, wherein the sheet material holder is produced by an additive manufacturing method.

24. A gripping system for holding sheet material, comprising:
a first sheet material holder and a second sheet material holder according to claim 16; and
wherein the sheet material holders are arranged on the gripping system in such a way that the first surface of the first sheet material holder faces the first surface of the second sheet material holder, and the gripping system is designed to hold sheet material between the first surface of the first sheet material holder and the first surface of the second sheet material holder.

25. The gripping system according to claim 24, wherein the sheet material holders are arranged in such a way that the first sheet material holder can be moved relative to the second sheet material holder in order to change a distance between the first surface of the first sheet material holder and the first surface of the second sheet material holder.

26. The gripping system according to claim 24, wherein the gripping system has a translational drive, which is designed to change the distance between the first surface of the first sheet material holder and the first surface of the second sheet material holder, increase it in order to release the sheet material from the sheet material holders.

27. The gripping system according to claim 24, wherein the sheet material holders are arranged in such a way that the first surface of the first sheet material holder is oblique with respect to the first surface of the second sheet material holder when the first sheet material holder and the second sheet material holder are not holding any sheet material,
wherein the gripping system is designed such that the first surface of the first sheet material holder can be aligned parallel to the first surface of the second sheet material holder, counter to a restoring force.

28. A set-down system for setting down sheet material, comprising:
one or two sheet material holders or the gripping system according to claim 24;
optionally a fluid supply unit, which is fluidically connected to the sheet material holder and is designed to discharge the fluid from the at least one first opening in the direction of the sheet material;
a movement system, which is designed to move the sheet material holder; and
a control device, which is designed:
to instruct the movement system to move sheet material to a set-down position when the sheet material is being held by the sheet material holder, and
to instruct a translational drive of the sheet material holder to increase a distance between the sheet material holder in order to release the sheet material from the sheet material holder, and
to instruct the fluid supply unit or a fluid supply unit that can be connected to the set-down system to discharge the fluid from the at least one first opening, and
to instruct the movement system to move the sheet material holder relative to the sheet material during the discharging of the fluid in such a way that the sheet material is set down from the sheet material holder.

29. A method for setting down sheet material, comprising the steps of:
moving sheet material to a set-down position, wherein the sheet material is held by at least one sheet material holder,
wherein a surface of the at least one sheet material holder bears on the sheet material;
increasing a distance between a first and a second of the at least one sheet material holder in order to release the sheet material held between the first sheet material holder and the second sheet material holder from the sheet material holders;
discharging a fluid from at least one opening in the surface of the at least one sheet material holder, wherein the fluid is discharged in the direction of the sheet material; and
moving the at least one sheet material holder relative to the sheet material during the discharging of the fluid, such that the sheet material is set down from the at least one sheet material holder.

30. The method according to claim 29, wherein the discharging of the fluid is started only for the setting down of the sheet material even before or simultaneously with the step of moving the at least one sheet material holder relative to the sheet material, which is carried out for the purpose of set-down.
